(19) United States
(12) Patent Application Publication
(10) Pub. No.: US 2026/0289095 A1
(43) Pub. Date: Sep. 24, 2026

(54) DATA PROCESSING SYSTEM AND DATA PROCESSING METHOD

(71) Applicant: Semiconductor Energy Laboratory Co., Ltd., Atsugi-shi (JP)

(72) Inventors: Junpei MOMO, Sagamihara (JP); Tatsuya OKANO, Isehara (JP)

(21) Appl. No.: 19/558,589

(22) Filed: Mar. 6, 2026

(30) Foreign Application Priority Data
Mar. 19, 2025 (JP) 2025-044853

(51) Int. Cl. G06F 40/169; G06F 40/40

(52) U.S. Cl. CPC G06F 40/169; G06F 40/40

(57) ABSTRACT

A novel data processing system comprising a first component, a second component, and a third component is provided. The first component receives a document, prior art literature, and a scope of claims and transmits them to the third component; the second component performs processing with a large language model; and the third component shares the received data and creates prompts. The third component has a function of creating and executing a prompt chain and a function of creating an annotated document. The system is configured to find a description related to the scope of claims in the prior art literature and a description related to the description in the prior art literature from the document. The system is configured to attach an annotation to a position of the description in the document.

### BACKGROUND OF THE INVENTION

### 1. Field of the Invention

One embodiment of the present invention relates to a data processing system, a data processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include a data processing device, a semiconductor device, a memory device, a method for driving any of these devices, and a method for manufacturing any of these devices.

### 2. Description of the Related Art

In recent years, language models using neural networks have been actively developed, and especially large language models (LLM) have attracted attention. A large language model is a natural language processing model trained using a large amount of data. With a large language model, for example, an interactive model that gives an answer to a user's instruction can be achieved. In Non-Patent Document 1, Generative Pre-trained Transformer 4 (GPT-4, registered trademark) is disclosed as a large language model, and ChatGPT (registered trademark) is disclosed as an interactive model.

By utilizing a large language model, the capability of a natural language processing model has been significantly increased. On the other hand, owing to the expansion of the language model, it is difficult to incorporate and operate a language model on one's own from the aspect of facilities and costs. Accordingly, utilizing an external service that provides a language model is one of the utility forms of a language model.

### Reference

### Non-Patent Document

Non-Patent Document 1 Summary of ChatGPT/GPT-4 Research and Perspective Towards the Future of Large Language Models, Yiheng Liu et al., (submitted on Apr. 4, 2023) [online], Internet URL: https://arxiv.org/abs/2304.01852

### SUMMARY OF THE INVENTION

One object of one embodiment of the present invention is to provide a novel data processing system that is highly convenient, useful, or reliable. Another object of one embodiment of the present invention is to provide a novel data processing method that is highly convenient, useful, or reliable. Another object of one embodiment of the present invention is to provide a novel data processing system, a novel data processing method, or a novel semiconductor device.

Note that the description of these objects does not preclude the existence of other objects. One embodiment of the present invention does not need to achieve all of these objects. Other objects will be apparent from and can be derived from the description of the specification, the drawings, the claims, and the like.

(1) One embodiment of the present invention is a data processing system configured to receive a scope of claims, a document, and prior art literature; and to provide an annotated document.

The prior art literature includes a first description related to the scope of claims. The annotated document is a document in which an annotation is attached to a position of a second description related to the first description in the above document. The annotation includes the first description.

(2) One embodiment of the present invention is a data processing system including a first component, a second component, and a third component.

The first component is configured to receive a scope of claims, a document, and prior art literature and transmit the scope of claims, the document, and the prior art literature to the third component; and to receive and provide a first annotated document. The prior art literature includes a first description related to the scope of claims. The first annotated document includes the document and a first annotation. The first annotated document is a document in which the first annotation is attached to a position identified by first positional data in the above document.

The second component is configured to receive a first prompt and a second prompt; to transmit the first description and the first positional data to the third component; and to perform processing with a large language model. The large language model is configured to extract the first description in accordance with the first prompt; and to generate the first positional data in accordance with the second prompt.

The third component is configured to receive the scope of claims, the document, the prior art literature, the first description, and the first positional data and share the scope of claims, the document, the prior art literature, the first description, and the first positional data inside the third component; to create the first prompt and the second prompt and transmit the first prompt and the second prompt to the second component; and to create the first annotated document and transmit the first annotated document to the first component. The third component includes a first subcomponent and a second subcomponent.

The first subcomponent is configured to create and execute a first prompt chain. The first prompt chain includes the first prompt and the second prompt. The first prompt includes a first instruction, the scope of claims, and the prior art literature. The first instruction includes a procedure for extracting the first description related to the scope of claims from the prior art literature. The second prompt includes a second instruction, the first description, and the document. The second instruction includes a procedure for searching the document for a second description related to the first description and generating the first positional data from a position of the second description.

The second subcomponent is configured to create the first annotated document from the document and the first positional data.

With the above data processing system, the first description related to the scope of claims can be found from the prior art literature. The second description related to the first description can be found from the document. The first positional data of the second description in the document can be identified. The first annotation can be attached to the position identified by the first positional data. The first annotation indicating relation to the first description in the prior art literature can be attached to the second description. The first annotation can call attention to a user of the data processing system, for example. As a result, a novel data processing system that is highly convenient, useful, or reliable can be provided.

(3) One embodiment of the present invention is the data processing system in which the first annotation includes the first description.

The second subcomponent is configured to create the first annotated document from the document, the first positional data, and the first description.

With the above data processing system, the first description, which is related to the scope of claims, in the prior art literature can be used in the first annotation. In the first annotation attached to the second description, the first description, which is related to the scope of claims, in the prior art literature can be used. With the use of the first annotation, revision of the document can be suggested to a user of the data processing system, for example. As a result, a novel data processing system that is highly convenient, useful, or reliable can be provided.

(4) One embodiment of the present invention is the data processing system in which the first component is configured to receive and provide a second annotated document. The second annotated document includes the document and a second annotation. The second annotated document is a document in which the second annotation is attached to the position identified by the first positional data in the above document. The second annotation includes a concise description.

The second component is configured to receive a third prompt and transmit the concise description to the third component. The large language model is configured to generate the concise description in accordance with the third prompt.

The third component is configured to transmit the third prompt to the second component; to receive the concise description and share the concise description inside the third component; and to create the second annotated document and transmit the second annotated document to the first component.

The first subcomponent is configured to create the third prompt. The third prompt includes a third instruction, the first description, and the second description. The third instruction includes a procedure for generating the concise description from the second description with reference to the first description.

The second subcomponent is configured to create the second annotated document from the document, the first positional data, and the concise description.

With the above data processing system, the concise description can be generated from the second description in the document. The concise description can be generated from the second description, which is related to the first description found in the prior art literature. The second annotation can be attached to the position identified by the first positional data. An example of the concise description of the second description can be used in the second annotation which can be attached to the second description. With the use of the second annotation, revision of the document can be suggested to a user of the data processing system, for example. As a result, a novel data processing system that is highly convenient, useful, or reliable can be provided.

(5) One embodiment of the present invention is the data processing system in which the first component is configured to receive and provide a third annotated document.

The third annotated document includes the document and a third annotation. The third annotated document is a document in which the third annotation is attached to a position identified by second positional data in the above document. The third annotation includes an abstract language expression and a specific language expression.

The second component is configured to receive a fourth prompt, a fifth prompt, and a sixth prompt and transmit the third positional data, a technical feature, the abstract language expression, and the specific language expression to the third component. The large language model is configured to generate the third positional data in accordance with the fourth prompt; to extract the technical feature in accordance with the fifth prompt; and to generate the abstract language expression and the specific language expression in accordance with the sixth prompt.

The third component is configured to create the fourth prompt, the fifth prompt, and the sixth prompt and transmit the fourth prompt, the fifth prompt, and the sixth prompt to the second component; to receive the third positional data, the technical feature, the abstract language expression, and the specific language expression and share the third positional data, the technical feature, the abstract language expression, and the specific language expression inside the third component; and to create the third annotated document and transmit the third annotated document to the first component.

The first subcomponent is configured to create and execute a second prompt chain; and to create second positional data. The second prompt chain includes the fourth prompt and the fifth prompt. The second positional data is a difference set obtained by removing the first positional data from the third positional data. The fourth prompt includes a fourth instruction, the scope of claims, and the document. The fourth instruction includes a procedure for searching the document for a description related to the scope of claims and generating the third positional data from a position of the description related to the scope of claims. The fifth prompt includes a fifth instruction, the document, and the second positional data. The fifth instruction includes a procedure for extracting the technical feature from a description in the document at a position identified by the second positional data. The sixth prompt includes a sixth instruction and the technical feature. The sixth instruction includes a procedure for generating the abstract language expression including the technical feature and the specific language expression included in the technical feature.

The second subcomponent is configured to create the third annotated document from the document, the second positional data, the abstract language expression, and the specific language expression.

With the above data processing system, the description related to the scope of claims can be found from the document, and the second positional data of the description in the document can be identified. The third positional data can be identified by using the difference set obtained by removing the first positional data from the second positional data. The third positional data of the description that is related to the scope of claims and cannot be found in the prior art literature can be identified. The technical feature can be extracted from the description in the document at the position identified by the third positional data. The abstract language expression including the technical feature and the specific language expression included in the technical feature can be generated. The abstract language expression including the technical feature and the specific language expression included in the technical feature can be used in the third annotation. The third annotation including the abstract language expression and the specific language expression can be attached to the position identified by the third positional data. With the use of the third annotation, revision of the scope of claims or the document can be suggested to a user of the data processing system, for example. As a result, a novel data processing system that is highly convenient, useful, or reliable can be provided.

(6) One embodiment of the present invention is a data processing method comprising a first step, a second step, a third step, a fourth step, a fifth step, a sixth step, a seventh step, an eighth step, a ninth step, a tenth step, an eleventh step, and a twelfth step.

In the first step, a first component receives a scope of claims, a document, and prior art literature and transmits the scope of claims, the document, and the prior art literature to a second component.

In the second step, the second component receives the scope of claims, the document, and the prior art literature and shares the scope of claims, the document, and the prior art literature inside the second component. The second component includes a first subcomponent and a second subcomponent.

In the third step, the first subcomponent creates a first prompt and transmits the first prompt to a third component. The first prompt includes a first instruction, the scope of claims, and the prior art literature. The first instruction includes a procedure for extracting a first description related to the scope of claims from the prior art literature.

In the fourth step, the third component receives the first prompt and generates the first description with a large language model.

In the fifth step, the third component transmits the first description to the second component.

In the sixth step, the second component receives the first description and shares the first description inside the second component.

In the seventh step, the first subcomponent creates a second prompt and transmits the second prompt to the third component. The second prompt includes a second instruction, the first description, and the document. The second instruction includes a procedure for searching the document for a second description related to the first description and generating first positional data from a position of the second description.

In the eighth step, the third component receives the second prompt and generates the first positional data with the large language model.

In the ninth step, the third component transmits the first positional data to the second component.

In the tenth step, the second component receives the first positional data and shares the first positional data inside the second component.

In the eleventh step, the second subcomponent creates a first annotated document from the document, the first positional data, and the first description and transmits the first annotated document to the first component.

The first annotated document is a document in which a first annotation is attached to the position identified by the first positional data in the above document. The first annotation includes the first description.

In the twelfth step, the first component receives and provides the first annotated document.

Through the above steps, the first description, which is related to the scope of claims, in the prior art literature can be used in the first annotation. In the first annotation attached to the second description, the first description, which is related to the scope of claims, in the prior art literature can be used. With the use of the first annotation, revision of the document can be suggested to a user of the data processing system, for example. As a result, a novel data processing method that is highly convenient, useful, or reliable can be provided.

(7) One embodiment of the present invention is the data processing method further including a thirteenth step, a fourteenth step, a fifteenth step, a sixteenth step, a seventeenth step, and an eighteenth step. The thirteenth step follows the twelfth step.

In the thirteenth step, the first subcomponent creates a third prompt and transmits the third prompt to the third component. The third prompt includes a third instruction, the first description, and the second description. The third instruction includes a procedure for generating a concise description from the second description with reference to the first description.

In the fourteenth step, the third component receives the third prompt and generates the concise description with the large language model.

In the fifteenth step, the third component transmits the concise description to the second component.

In the sixteenth step, the second component receives the concise description and shares the concise description inside the second component.

In the seventeenth step, the second subcomponent creates a second annotated document from the document, the first positional data, and the concise description and transmits the second annotated document to the first component.

The second annotated document is a document in which a second annotation is attached to the position identified by the first positional data in the above document. The second annotation includes the concise description.

In the eighteenth step, the first component receives and provides the second annotated document.

Through the above steps, the concise description can be generated from the second description in the document. The concise description can be generated from the second description, which is related to the first description found in the prior art literature. The second annotation can be attached to the position identified by the first positional data. An example of the concise description of the second description can be used in the second annotation which can be attached to the second description. With the use of the second annotation, revision of the document can be suggested to a user of the data processing system, for example. As a result, a novel data processing method that is highly convenient, useful, or reliable can be provided.

(8) One embodiment of the present invention is the data processing method further including a nineteenth step, a twentieth step, a twenty-first step, a twenty-second step, a twenty-third step, a twenty-fourth step, a twenty-fifth step, a twenty-sixth step, a twenty-seventh step, a twenty-eighth step, a twenty-ninth step, a thirtieth step, a thirty-first step, a thirty-second step, and a thirty-third step. The nineteenth step follows the twelfth step.

In the nineteenth step, the first subcomponent creates a fourth prompt and transmits the fourth prompt to the third component. The fourth prompt includes a fourth instruction, the scope of claims, and the document. The fourth instruction includes a procedure for searching the document for a description related to the scope of claims and generating second positional data from a position of the description related to the scope of claims.

In the twentieth step, the third component receives the fourth prompt and generates the second positional data with the large language model.

In the twenty-first step, the third component transmits the second positional data to the second component.

In the twenty-second step, the second component receives the second positional data and shares the second positional data inside the second component.

In the twenty-third step, the first subcomponent creates third positional data by removing the first positional data from the second positional data.

In the twenty-fourth step, the first subcomponent creates a fifth prompt and transmits the fifth prompt to the third component. The fifth prompt includes a fifth instruction, the document, and the third positional data. The fifth instruction includes a procedure for extracting a technical feature from a description in the document at a position identified by the third positional data.

In the twenty-fifth step, the third component receives the fifth prompt and extract the technical feature with the large language model.

In the twenty-sixth step, the third component transmits the technical feature to the second component.

In the twenty-seventh step, the second component receives the technical feature and shares the technical feature inside the second component.

In the twenty-eighth step, the first subcomponent creates a sixth prompt and transmits the sixth prompt to the third component. The sixth prompt comprises a sixth instruction and the technical feature. The sixth instruction includes a procedure for generating an abstract language expression including the technical feature and a specific language expression included in the technical feature.

In the twenty-ninth step, the third component receives the sixth prompt and generates the abstract language expression and the specific language expression with the large language model.

In the thirtieth step, the third component transmits the abstract language expression and the specific language expression to the second component.

In the thirty-first step, the second component receives the abstract language expression and the specific language expression and shares the abstract language expression and the specific language expression inside the second component.

In the thirty-second step, the second subcomponent creates a third annotated document from the document, the third positional data, the abstract language expression, and the specific language expression and transmits the third annotated document to the first component.

The third annotated document is a document in which a third annotation is attached to the position identified by the third positional data in the above document. The third annotation includes the abstract language expression and the specific language expression.

In the thirty-third step, the first component receives and provides the third annotated document.

Through the above steps, the description related to the scope of claims can be found from the document, and the second positional data of the description in the document can be identified. The third positional data can be identified by using the difference set obtained by removing the first positional data from the second positional data. The third positional data of the description that is related to the scope of claims and cannot be found in the prior art literature can be identified. The technical feature can be extracted from the description in the document at the position identified by the third positional data. The abstract language expression including the technical feature and the specific language expression included in the technical feature can be generated. The abstract language expression including the technical feature and the specific language expression included in the technical feature can be used in the third annotation. The third annotation including the abstract language expression and the specific language expression can be attached to the position identified by the third positional data. With the use of the third annotation, revision of the scope of claims or the document can be suggested to a user of the data processing system, for example. As a result, a novel data processing method that is highly convenient, useful, or reliable can be provided.

With one embodiment of the present invention, a novel data processing system that is highly convenient, useful, or reliable can be provided. A novel data processing method that is highly convenient, useful, or reliable can be provided. A novel data processing system, a novel data processing method, or a novel semiconductor device can be provided.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

FIG. 1 illustrates a structure of a data processing system of an embodiment.

FIG. 2A illustrates a structure of a component used in a data processing system of an embodiment, and FIG. 2B illustrates a structure of an annotated document using a drawing of an image displayed on a display device.

FIG. 3 illustrates a structure of a component used in a data processing system of an embodiment.

FIGS. 4A to 4C illustrate structures of prompts used in a data processing system of an embodiment.

FIG. 5A illustrates a structure of a component used in a data processing system of an embodiment, and FIG. 5B illustrates a structure of an annotated document using a drawing of an image displayed on a display device.

FIG. 6 illustrates a structure of a prompt used in a data processing system of an embodiment.

FIG. 7A illustrates a structure of a component used in a data processing system of an embodiment, and FIG. 7B illustrates a structure of an annotated document using a drawing of an image displayed on a display device.

FIGS. 8A to 8C illustrate structures of prompts used in a data processing system of an embodiment.

FIG. 9 illustrates a structure of a prompt used in a data processing system of an embodiment.

FIG. 10 illustrates a structure of a data processing device used for a data processing system of an embodiment.

FIG. 11 illustrates a data processing method of an embodiment.

FIG. 12 illustrates a data processing method of an embodiment.

FIG. 13 illustrates a data processing method of an embodiment.

### DETAILED DESCRIPTION OF THE INVENTION

A data processing system of one embodiment of the present invention includes a first component, a second component, and a third component. The first component has a function of receiving a scope of claims, a document, and prior art literature and transmitting them to the third component, and a function of receiving and providing a first annotated document. The prior art literature includes a first description related to the scope of claims, the first annotated document includes the document and a first annotation, and the first annotated document is a document in which the first annotation is attached to a position identified by first positional data in the above document.

The second component has a function of receiving a first prompt and a second prompt and transmitting the first description and the first positional data to the third component, and a function of performing processing with the use of a large language model. The large language model has a function of extracting the first description in accordance with the first prompt and a function of generating the first positional data in accordance with the second prompt.

The third component has a function of receiving the scope of claims, the document, the prior art literature, the first description, and the first positional data and sharing them inside the third component, a function of creating the first prompt and the second prompt and transmitting them to the second component, and a function of creating the first annotated document and transmitting it to the first component. The third component includes a first subcomponent and a second subcomponent.

The first subcomponent has a function of creating and executing a first prompt chain, and the first prompt chain includes the first prompt and the second prompt. The first prompt includes a first instruction, the scope of claims, and the prior art literature, and the first instruction includes a procedure for extracting the first description related to the scope of claims from the prior art literature. The second prompt includes a second instruction, the first description, and the document, and the second instruction includes a procedure for searching the document for a second description related to the first description and generating the first positional data from the position of the second description.

The second subcomponent has a function of creating the first annotated document from the document and the first positional data.

With the above data processing system, the first description related to the scope of claims can be found from the prior art literature. The second description related to the first description can be found from the document. The first positional data of the second description in the document can be identified. The first annotation can be attached to the position identified by the first positional data. The first annotation indicating relation to the first description in the prior art literature can be attached to the second description. The first annotation can call attention to a user of the data processing system, for example. As a result, a novel data processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as "first" and "second" in this specification and the like are used in order to avoid confusion among components and thus do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### EMBODIMENT 1

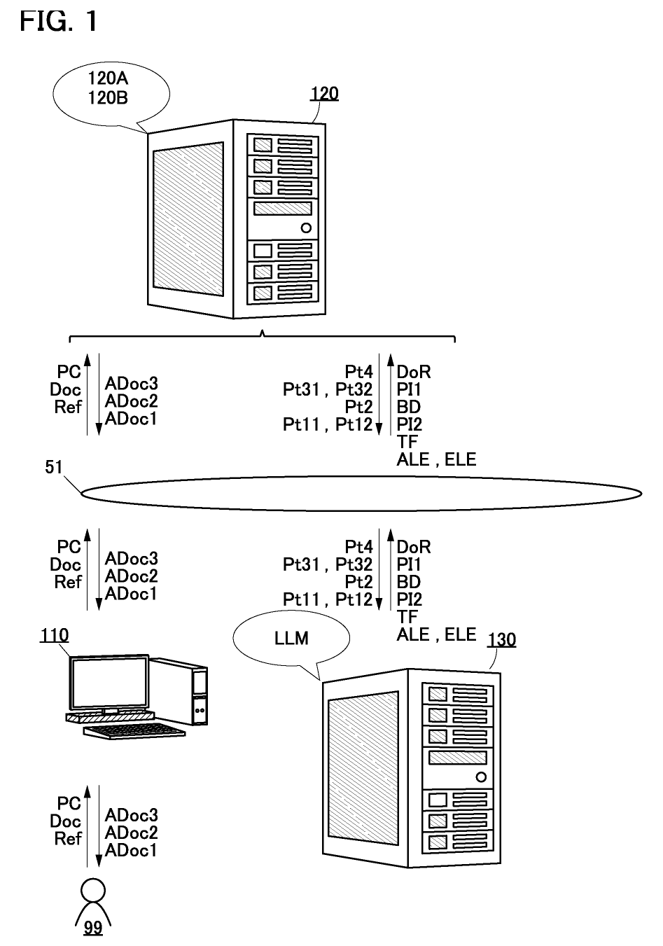

In this embodiment, a data processing system of one embodiment of the present invention will be described with reference to FIGS. 1, 2A and 2B, 3, 4A to 4C, 5A and 5B, 6, 7A and 7B, 8A to 8C, 9 and 10.

FIG. 1 illustrates the structure of the data processing system of one embodiment of the present invention.

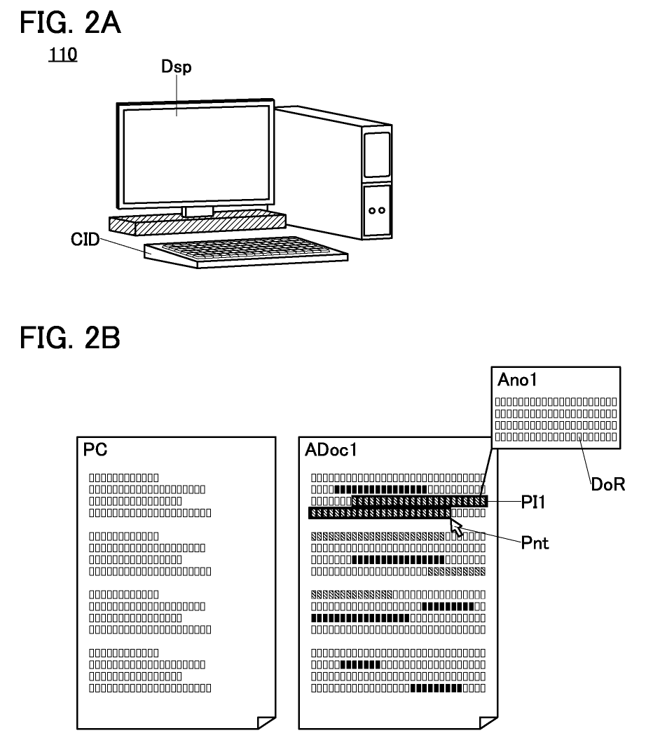

FIG. 2A illustrates the structure of a component that can be used in the data processing system of one embodiment of the present invention, and FIG. 2B illustrates, using a drawing of an image displayed on a display device, the structure of an annotated document provided by the data processing system of one embodiment of the present invention.

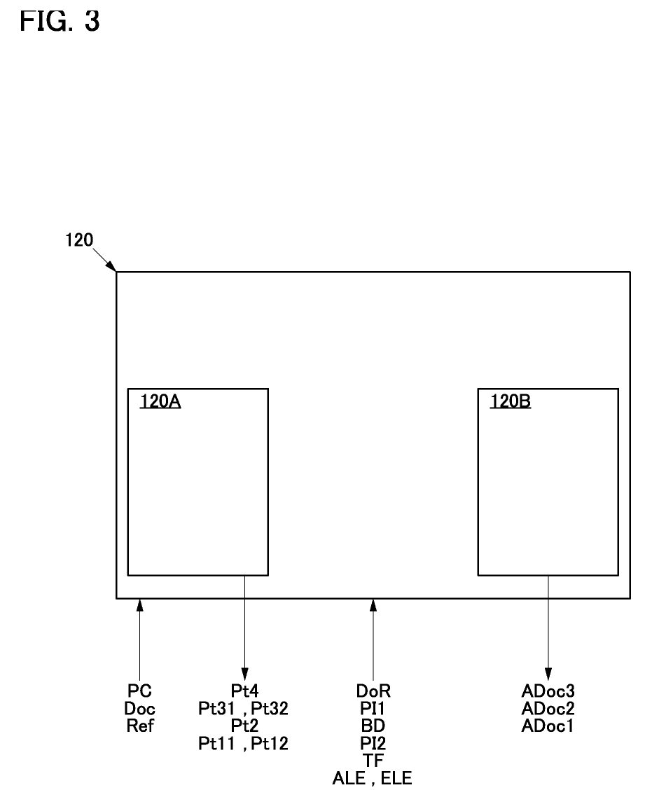

FIG. 3 illustrates the structure of a component used in the data processing system of one embodiment of the present invention.

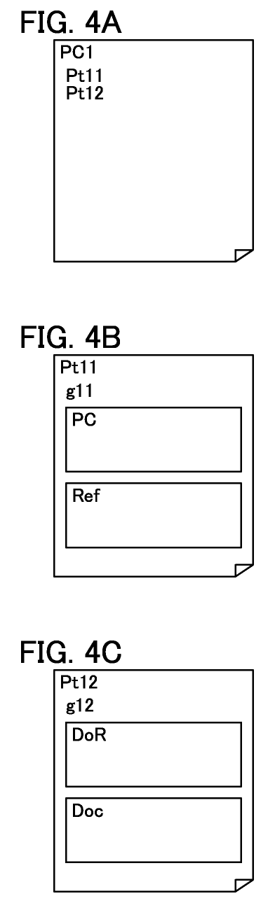

FIG. 4A illustrates the structure of a prompt chain used in the data processing system of one embodiment of the present invention, and FIGS. 4B and 4C each illustrate the structure of a prompt that is transmitted and received inside the data processing system.

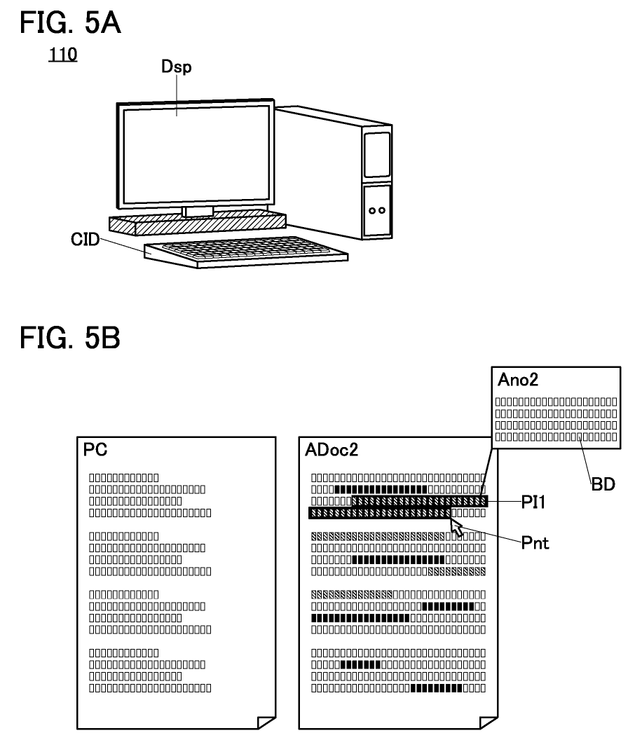

FIG. 5A illustrates the structure of the component that can be used in the data processing system of one embodiment of the present invention, and FIG. 5B illustrates, using a drawing of an image displayed on the display device, the structure of an annotated document provided by the data processing system of one embodiment of the present invention.

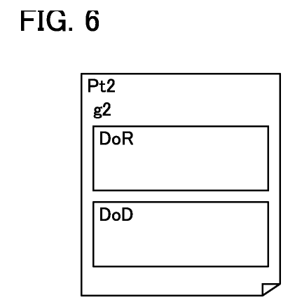

FIG. 6 illustrates the structure of a prompt that is transmitted and received inside the data processing system of one embodiment of the present invention.

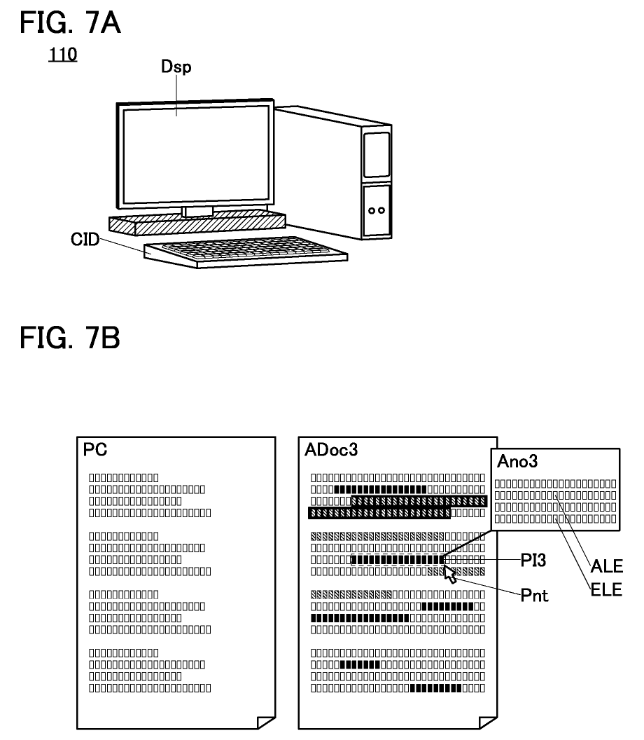

FIG. 7A illustrates the structure of the component that can be used in the data processing system of one embodiment of the present invention, and FIG. 7B illustrates, using a drawing of an image displayed on the display device, the structure of an annotated document provided by the data processing system of one embodiment of the present invention.

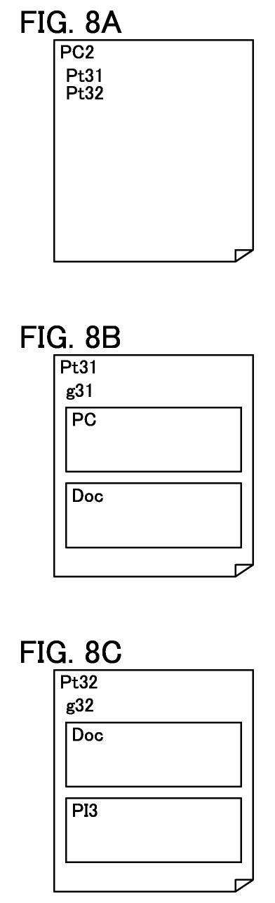

FIG. 8A illustrates the structure of a prompt chain used in the data processing system of one embodiment of the present invention, and FIGS. 8B and 8C each illustrate the structure of a prompt that is transmitted and received inside the data processing system.

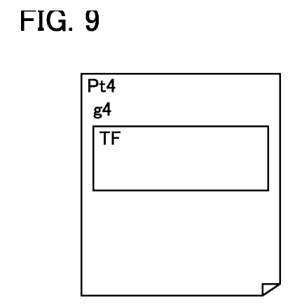

FIG. 9 illustrates the structure of a prompt that is transmitted and received inside the data processing system of one embodiment of the present invention.

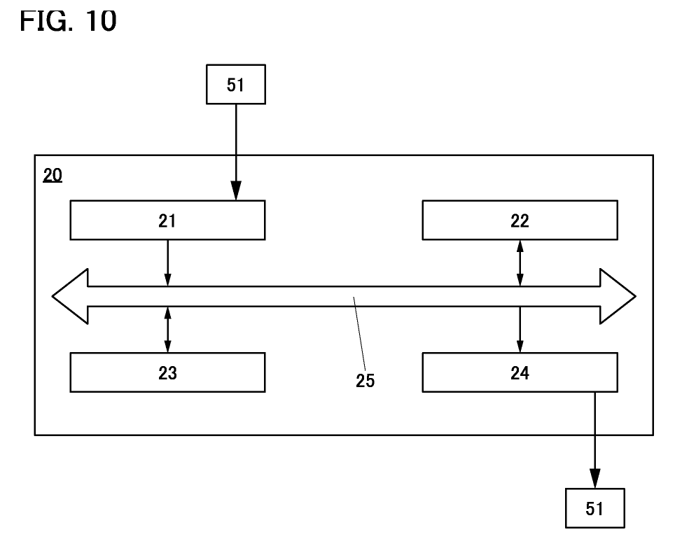

FIG. 10 is a block diagram illustrating the structure of a data processing device which can be used in the data processing system of one embodiment of the present invention.

### Structure example 1 of data processing system

The data processing system of one embodiment of the present invention includes a component 110, a component 130, and a component 120 (see FIG. 1).

A data processing device having a function of the component 110, a data processing device having a function of the component 130, and a data processing device having a function of the component 120 each include an arithmetic unit and a communication device, for example. The communication devices can be connected to each other via a network 51 to construct the data processing system of one embodiment of the present invention.

### Structure example 1 of component 110

The component 110 has a function of receiving a scope of claims PC, a document Doc, and prior art literature Ref, and transmitting them to the component 120, for example.

For example, a document describing a structure which is recognized as necessary for identifying an invention for which a patent is sought can be used for the scope of claims PC. A document describing how an invention is implemented can be used as the document Doc. A document described so that a person with ordinary knowledge in the technical field of an invention for which a patent is sought can implement the invention can be used as the document Doc. A document described so that an invention can be specifically implemented can be used as the document Doc. Note that in this specification, the document Doc includes a document describing an embodiment of an invention, preferably includes a document specifically describing an embodiment of an invention.

The prior art literature Ref includes a description DoR related to the scope of claims PC. Note that one or more pieces of literature can be used as the prior art literature Ref. Moreover, a material compiled from a plurality of pieces of literature can be used as the prior art literature Ref.

For example, a user 99 of the data processing system inputs the scope of claims PC, the document Doc, and the prior art literature Ref to the component 110. Alternatively, for example, a command for selecting and transmitting the scope of claims PC, the document Doc, and the prior art literature Ref that are stored in a variety of memory devices is input to the component 110. Specifically, the user 99 of the data processing system inputs the scope of claims PC, the document Doc, and the prior art literature Ref or the command to the component 110 using an input device such as a keyboard, a mouse, a facsimile machine, or an eye-gaze input device.

The component 110 has a function of receiving an annotated document ADoc1 and providing it to the user 99 of the data processing system, for example. Specifically, the annotated document ADoc1 is provided to the user 99 of the data processing system with an output device such as a display device, a speaker, a printer, a facsimile machine, or a variety of memory devices.

The component 110 includes a display device Dsp and an input device CID, for example (see FIG. 2A). The display device Dsp has a function of displaying the scope of claims PC, the annotated document ADoc1, and a pointer Pnt. The input device CID has a function of moving the pointer Pnt (see FIG. 2B). For example, an annotation Ano1 can be displayed when the pointer Pnt is in a region identified by positional data PI1. In addition, the user of the data processing system can select a button displayed on the display device Dsp with the use of the pointer Pnt, for example. A button having a function of selecting an annotation to be displayed on the display device Dsp from a plurality of annotations can be displayed on the display device Dsp, for example.

### Structure example 1 of annotated document ADoc1

The annotated document ADoc1 includes the document Doc and the annotation Ano1 (see FIG. 2B). The annotated document ADoc1 is the document Doc in which the annotation Ano1 is attached to a position identified by the positional data PI1. For example, a decoration applied to a character can be used for an annotation. Specifically, at least one of a highlight, a bold letter, an italic letter, and an underline can be used for an annotation.

For example, a tag for displaying a decoration is attached to a region in the document Doc, which is identified by the positional data PI1. Dedicated application software or a web browser can display the predetermined decoration in the region to which the predetermined tag is attached.

As the positional data PI1, the number of characters counted from the first character of the document Doc to a character to which the annotation Ano1 is attached can be used, for example. Alternatively, the number of characters in a region to which the annotation Ano1 is attached can be used as the positional data PI1. Further alternatively, in the case where the document Doc is divided using paragraph numbers, for example, any of the paragraph numbers can be used as the positional data PI1. As for the positional data PI1, a variety of known techniques can be applied. The positional data PI1 can be composed of one or more elements. In the case where the positional data PI1 is composed of a plurality of elements, the elements each identify a position to which the annotation Ano1 is attached.

### Structure example 1 of component 130

The component 130 has a function of receiving a prompt Pt11 and a prompt Pt12 and transmitting the description DoR and the positional data PI1 to the component 120 (see FIG. 1). In addition, the component 130 has a function of performing processing with a large language model LLM.

### Structure example 1 of large language model LLM

The large language model LLM has a function of extracting the description DoR in accordance with the prompt Pt11 and a function of generating the positional data PIb in accordance with the prompt Pt12.

For example, a large language model such as GPT-3 (registered trademark), GPT-3.5, GPT-4 (registered trademark), LaMDA, Llama2, or Llama3 can be used as the large language model LLM. Note that character information written in characters is referred to as a document in this specification and the like. The term "document" includes characters, character strings, texts, sentences, papers, and the like.

### Structure example 1 of component 120

The component 120 has a function of receiving the scope of claims PC, the document Doc, the prior art literature Ref, the description DoR, and the positional data PI1 and sharing them inside the component 120.

The component 120 has a function of creating the prompt Pt11 and the prompt Pt12 and transmitting them to the component 130. The component 120 has a function of creating the annotated document ADoc1 and transmitting it to the component 110.

The component 120 includes a subcomponent 120A and a subcomponent 120B (see FIG. 3). In this specification, a structure having a single function or a plurality of functions is referred to as a component or a subcomponent for description convenience.

### Structure example 1 of subcomponent 120A

The subcomponent 120A has a function of creating and executing a prompt chain PC1. The prompt chain PCb includes the prompt Pt11 and the prompt Pt12 (see FIG. 4A). The prompt chain is a technique in which a response to a prompt is used as part of the next prompt.

### Structure example of prompt Pt11

The prompt Pt11 includes an instruction g11, the scope of claims PC, and the prior art literature Ref (see FIG. 4B). The instruction g11 includes a procedure for extracting the description DoR related to the scope of claims PC from the prior art literature Ref.

For example, the following text can be used as the prompt Pt11.

Divide the scope of claims PC into elements and answer the descriptions DoR related to the elements and disclosed in the prior art literature Ref.

Scope of claims PC

Prior art literature Ref

### Structure example of prompt Pt12

The prompt Pt12 includes an instruction g12, the description DoR, and the document Doc (see FIG. 4C). The instruction g12 includes a procedure for searching the document Doc for a description DoD related to the description DoR and generating the positional data PI1 of the description DoD.

For example, the following text can be used as the prompt Pt12. Note that the large language model generates a paragraph number of the document Doc as the positional data PI1.

Answer a paragraph number of a paragraph including the description DoR in the document Doc.

### Description DoR

### Document DoC

### Structure example 1 of subcomponent 120B

The subcomponent 120B has a function of creating the annotated document ADoc1 from the document Doc and the positional data PI1 (see FIG. 3).

In this manner, the description DoR related to the scope of claims PC can be found from the prior art literature Ref. The description DoD related to the description DoR can be found from the document Doc. The positional data PI1 of the description DoD in the document Doc can be identified. The annotation Ano1 can be attached to the position identified by the positional data PI1. The annotation Ano1 indicating relation to the description DoR in the prior art literature Ref can be attached to the description DoD. The annotation Ano1 can call attention to the user of the data processing system, for example. As a result, a novel data processing system that is highly convenient, useful, or reliable can be provided.

### Structure example 2 of subcomponent 120B

Not only a decoration applied to a character, but also a character string or a sentence can be used for an annotation. The subcomponent 120B has a function of creating the annotated document ADoc1 from the document Doc, the positional data PI1, and the description DoR.

### Structure example 2 of annotated document ADoc1

The annotated document ADoc1 is the document Doc in which the annotation Ano1 is attached to the position identified by the positional data PI1, and the annotation Ano1 includes the description DoR extracted from the prior art literature Ref (see FIG. 2B).

Thus, the description DoR, which is related to the scope of claims PC, in the prior art literature Ref can be used in the annotation Ano1. In other words, in the annotation Ano1 attached to the description DoD, the description DoR, which is related to the scope of claims PC, in the prior art literature Ref can be used. With the use of the annotation Ano1, revision of the document Doc can be suggested to the user of the data processing system, for example. As a result, a novel data processing system that is highly convenient, useful, or reliable can be provided.

### Structure example 2 of component 110

Instead of the description DoR extracted from the prior art literature Ref, data generated by the large language model LLM can be used in an annotation. The component 110 has a function of receiving an annotated document ADocb in which data generated by the large language model LLM is used in an annotation, and providing the annotated document ADoc2 to the user 99 of the data processing system, for example (see FIG. 1).

The component 110 includes the display device Dsp and the input device CID, for example (see FIG. 5A). The display device Dsp has a function of displaying the scope of claims PC, the annotated document ADoc2, and the pointer Pnt (see FIG. 5B). The input device CID has a function of moving the pointer Pnt.

### Structure example of annotated document ADoc2

The annotated document ADoc2 includes the document Doc and an annotation Ano2 (see FIG. 5B). The annotated document ADoc2 is the document Doc in which the annotation Ano2 is attached to the position identified by the positional data PI1. The annotation Ano2 includes a concise description BD generated by the large language model LLM. In the case where the description DoD is related to the description DoR extracted from the prior art literature Ref, for example, the user of the data processing system can gain insight from the concise description BD and consider whether or not the description DoD is too detailed, or whether or not the description DoD can be more concise.

### Structure example 2 of the component 130

The component 130 has a function of receiving a prompt Pt2 and transmitting the concise description BD to the component 120 (see FIG. 1).

### Structure example 2 of large language model LLM

The large language model LLM has a function of generating the concise description BD in accordance with the prompt Pt2.

### Structure example 2 of component 120

The component 120 has a function of transmitting the prompt Pt2 to the component 130 and a function of receiving the concise description BD and sharing it inside the component 120. In addition, the component 120 has a function of creating the annotated document ADoc2 and transmitting it to the component 110.

### Structure example 2 of subcomponent 120A

The subcomponent 120A has a function of creating the prompt Pt2 (see FIG. 3).

### Structure example of prompt Pt2

The prompt Pt2 includes an instruction g2, the description DoR extracted from the prior art literature Ref, and the description DoD extracted from the document Doc (see FIG. 6). The instruction g2 includes a procedure for generating the concise description BD from the description DoD with reference to the description DoR.

For example, the following text can be used as the prompt Pt2.

Simplify the description DoD to be as concise as the description DoR. Do not change the description DoD in the case where the description DoR is more detailed than the description DoD.

### Description DoR

### Description DoD

### Structure example 3 of subcomponent 120B

The subcomponent 120B has a function of creating the annotated document ADoc2 from the document Doc, the positional data PI1, and the concise description BD (see FIG. 3). Specifically, an annotation including the concise description BD is attached to the position in the document Doc, which is identified by the positional data PI1.

Thus, the concise description BD can be generated from the description DoD in the document Doc. In other words, the concise description BD can be generated from the description DoD, which is related to the description DoR found in the prior art literature Ref. The annotation Ano2 can be attached to the position identified by the positional data PI1. An example of the concise description BD of the description DoD can be used in the annotation Ano2 which can be attached to the description DoD. With the use of the annotation Ano2, revision of the document Doc can be suggested to the user of the data processing system, for example. As a result, a novel data processing system that is highly convenient, useful, or reliable can be provided.

### Structure example 3 of component 110

Instead of the concise description BD of the description DoD, a language expression generated by the large language model LLM can be used in an annotation. The component 110 has a function of receiving an annotated document ADoc3 in which an abstract language expression or a specific language expression generated by the large language model LLM is used in an annotation and providing the annotated document ADoc3 to the user 99 of the data processing system, for example (see FIG. 1).

The component 110 includes the display device Dsp and the input device CID, for example (see FIG. 7A). The display device Dsp has a function of displaying the scope of claims PC, the annotated document ADoc3, and the pointer Pnt (see FIG. 7B). The input device CID has a function of moving the pointer Pnt.

### Structure example of annotated document ADoc3

The annotated document ADoc3 includes the document Doc and an annotation Ano3 (see FIG. 7B). The annotated document ADoc3 is the document Doc in which the annotation Ano3 is attached to a position identified by positional data PI2. The annotation Ano3 includes an abstract language expression ALE and a specific language expression ELE that are generated by the large language model LLM. For example, the user of the data processing system can gain insight from the abstract language expression ALE and the specific language expression ELE and consider whether or not the description DoD is too detailed, or whether or not the description DoD should be more specific.

### Structure example 3 of component 130

The component 130 has a function of receiving a prompt Pt31, a prompt Pt32, and a prompt Pt4 and transmitting the positional data PIb, a technical feature TF, the abstract language expression ALE, and the specific language expression ELE to the component 120 (see FIG. 1).

### Structure example 3 of large language model LLM

The large language model LLM has a function of generating the positional data PI2 in accordance with the prompt Pt31, a function of extracting the technical feature TF in accordance with the prompt Pt32, and a function of generating the abstract language expression ALE and the specific language expression ELE in accordance with the prompt Pt4.

### Structure example 3 of component 120

The component 120 has a function of creating the prompt Pt31, the prompt Pt32, and the prompt Pt4 and transmitting them to the component 130. In addition, the component 120 has a function of receiving the positional data PI2, the technical feature TF, the abstract language expression ALE, and the specific language expression ELE and sharing them inside the component 120. Moreover, the component 120 has a function of creating the annotated document ADoc3 and transmitting it to the component 110.

### Structure example 3 of subcomponent 120A

The subcomponent 120A has a function of creating and executing a prompt chain PC2 and a function of creating positional data PI3. The prompt chain PC2 includes the prompt Pt31 and the prompt Pt32 (see FIG. 8A).

### Structure example of prompt Pt31

The prompt Pt31 includes an instruction g31, the scope of claims PC, and the document Doc (see FIG. 8B). The instruction g31 includes a procedure for searching the document Doc for a description related to the scope of claims PC and generating the positional data PI2 from the position of the description related to the scope of claims. The positional data PI2 is composed of one or more elements. The positional data PI1 is included in the positional data PI2.

For example, the following text can be used as the prompt Pt31. Note that the large language model generates a paragraph number of the document Doc as the positional data PI2.

Divide the scope of claims PC into elements and answer paragraph numbers of paragraphs including descriptions related to the elements in the document Doc.

Scope of claims PC

Document Doc

### Structure example of positional data PI3

The positional data PI3 created by the subcomponent 120A is the difference set obtained by removing the positional data PI1 from the positional data PI2, and the positional data PI3 is part of the positional data PI2. Accordingly, the elements constituting the positional data PI1 and the elements constituting the positional data PI3 do not overlap with each other.

In other words, the description at the position identified by the positional data PI2 is the description related to the scope of claims PC, which is found in the document Doc. The description at the position identified by the positional data PI1 is the description found in the document Doc and related to the description DoR, which is related to the scope of claims PC and found in the prior art literature Ref. A description at a position identified by the positional data PI3 is a description obtained by removing the description related to the description DoR from the descriptions related to the scope of claims PC and found in the document Doc.

Accordingly, the positional data PI3 identifies the position of the description that cannot be found in the prior art literature Ref among the descriptions related to the scope of claims PC, which are found in the document Doc. In other words, the positional data PI3 identifies the position of the description which can be expected to have novelty among the descriptions related to the scope of claims PC.

### Structure example of prompt Pt32

The prompt Pt32 includes an instruction g32, the document Doc, and the positional data PI3 (see FIG. 8C). The instruction g32 includes a procedure for extracting the technical feature TF from the description in the document Doc at the position identified by the positional data PI3.

For example, the following text can be used as the prompt Pt32.

Answer a technical feature of the description at the position identified by the positional data PI3 in the document Doc.

Document Doc

Positional data PI3

### Structure example of prompt Pt4

The prompt Pt4 includes an instruction g4 and the technical feature TF (see FIG. 9). The instruction g4 includes a procedure for generating the abstract language expression ALE including the technical feature TF and the specific language expression ELE included in the technical feature TF. The abstract language expression ALE is a language expression that expresses a superordinate concept including the extracted technical feature TF. In addition, the specific language expression ELE is a language expression that expresses a subordinate concept included in the extracted technical feature TF.

For example, in the case where the technical feature TF is a central processing unit (CPU), an arithmetic circuit can be given as an example of the abstract language expression ALE. In the case where the technical feature TF is an arithmetic circuit, examples of the specific language expression ELE include a CPU, a neural processing unit (NPU), and a graphics processing unit (GPU).

For example, the following text can be used as the prompt Pt4.

Suggest a more abstract expression regarding the technical feature TF. Also suggest a more specific expression regarding the technical feature TF. Suggest as many specific expressions as possible.

Technical feature TF

### Structure example 4 of subcomponent 120B

The subcomponent 120B has a function of creating the annotated document ADoc3 from the document Doc, the positional data PI3, the abstract language expression ALE, and the specific language expression ELE (see FIG. 3). Specifically, an annotation including the abstract language expression ALE and the specific language expression ELE is attached to the position in the document Doc, which is identified by the positional data PI3.

In this manner, the description related to the scope of claims PC can be found from the document Doc and the positional data PI2 of the description in the document Doc can be identified. The positional data PI3 can be identified by using the difference set obtained by removing the positional data PI1 from the positional data PI2. The positional data PI3 of the description that is related to the scope of claims PC and cannot be found in the prior art literature Ref can be identified. The technical feature TF can be extracted from the description in the document Doc at the position identified by the positional data PI3. The abstract language expression ALE including the technical feature TF and the specific language expression ELE included in the technical feature TF can be generated. The abstract language expression ALE including the technical feature TF and the specific language expression ELE included in the technical feature TF can be used in the annotation Ano3. The annotation Ano3 including the abstract language expression ALE and the specific language expression ELE can be attached to the position identified by the positional data PI3. With the use of the annotation Ano3, revision of the scope of claims PC or the document Doc can be suggested to the user of the data processing system, for example. In addition, the user of the data processing system can enrich a description that would be patentable, for example. As a result, a novel data processing system that is highly convenient, useful, or reliable can be provided.

### Structure example 2 of data processing system

The data processing system described in this embodiment includes the component 110, the component 120, and the component 130 (see FIG. 1).

The data processing system of one embodiment of the present invention can be composed of a data processing device having a function of the component 110, a data processing device having a function of the component 120, and a data processing device having a function of the component 130, for example. Note that the number of data processing devices constituting the data processing system of one embodiment of the present invention is one or more. For example, a plurality of data processing devices can be connected to each other using the network 51 to construct the data processing system of one embodiment of the present invention.

When the data processing system of one embodiment of the present invention is constituted with a plurality of data processing devices, loads relating to data processing can be dispersed.

### Structure example 1 of data processing device

A data processing device with Structure example 1 described in this embodiment can be used as the component 110. The data processing device with Structure example 1 can be referred to as a client computer or the like. For example, a desktop computer or a mobile computer can be used as the component 110.

The data processing device with Structure example 1 can receive data input by the user of the data processing system of one embodiment of the present invention. The data processing device with Structure example 1 can provide data output from the data processing system of one embodiment of the present invention to the user.

For example, dedicated application software or a web browser operates in the component 110. Via either of them, the user of the data processing system of one embodiment of the present invention can access the data processing system. Thus, the user can receive service using the data processing system of one embodiment of the present invention.

### Structure example 2 of data processing device

A data processing device with Structure example 2 described in this embodiment can be used as the component 120. For example, a workstation, a server computer, or a supercomputer can be used as the component 120.

The data processing device with Structure example 2 preferably has a function of a parallel computer. When the data processing device with Structure example 2 is used as a parallel computer, large-scale computation necessary for artificial intelligence (AI) learning and inference can be performed, for example.

Furthermore, the data processing device with Structure example 2 can perform processing using a natural language model with the use of AI.

For example, it is preferable that the data processing device be capable of performing processing using a natural language model such as GPT-3 (registered trademark), GPT-3.5, GPT-4 (registered trademark), LaMDA, Llama2, or Llama3.

### Structure example 3 of data processing device

A data processing device with Structure example 3 described in this embodiment can be used as the component 130, for example. Note that the component 130 has a larger scale and higher computational capability than the component 120. For example, a large computer such as a server computer or a supercomputer can be used as the component 130.

The data processing device with Structure example 3 preferably has a function of a parallel computer. When the data processing device with Structure example 3 is used as a parallel computer, large-scale computation necessary for AI learning and inference can be performed, for example.

Furthermore, the data processing device with Structure example 3 can perform processing using a natural language model with the use of AI. In particular, it is possible to perform processing using a general-purpose language model capable of performing a variety of natural language processing tasks.

For example, processing using a natural language model such as GPT-3 (registered trademark), GPT-3.5, GPT-4 (registered trademark), LaMDA, Llama2, or Llama3 can be performed. In particular, it is preferable that processing using GPT-4 (registered trademark) be available. For example, processing using a language model that is larger in scale than a conventional natural language model can achieve more natural text generation, interaction, or the like.

Note that a service provider using the data processing system of one embodiment of the present invention does not necessarily have its own data processing device with Structure example 3. For example, a service provider can utilize part of the service that another company or the like provides using the data processing device with Structure example 3.

### Structure example of network 51

The network 51 that can be used for the data processing system of one embodiment of the present invention can connect a plurality of data processing devices to each other. Thus, the plurality of data processing devices connected to each other can transmit and receive data to and from each other. Furthermore, loads of the data processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the data processing system of one embodiment of the present invention can provide service using the data processing method of one embodiment of the present invention via the network 51, for example.

Note that in the case where the data processing system of one embodiment of the present invention is constructed in a local network, the possibility of leakage of confidential data can be lower than that in the case of utilizing the Internet, for example.

### Structure example of data processing device

A data processing device 20 that can be used in the data processing system of one embodiment of the present invention includes, for example, an input unit 21, a memory unit 22, a processing unit 23, an output unit 24, and a transmission path 25 (see FIG. 10).

Although a block diagram in which components are classified by their functions and shown as independent blocks is shown in the drawing attached to this specification, it is difficult to completely separate actual components according to their functions and one component can relate to a plurality of functions. For example, part of the processing unit 23 functions as the input unit 21 in some cases. In addition, one function can relate to a plurality of components. For example, processing performed in the processing unit 23 is sometimes executed by a different data processing device depending on the processing.

### Input unit 21

The input unit 21 can receive data from the outside of the data processing device. For example, the input unit 21 receives data via the network 51. Specifically, a device such as a personal computer having a communication port or a communication function can be used.

The input unit 21 supplies the received data to one or both of the memory unit 22 and the processing unit 23 via the transmission path 25.

### Memory unit 22

The memory unit 22 has a function of storing a program to be executed by the processing unit 23. The memory unit 22 can also have a function of storing data generated by the processing unit 23 (e.g., an arithmetic operation result, an analysis result, or an inference result), data received by the input unit 21, and the like.

The memory unit 22 can include a database. The data processing device can include a database in addition to the memory unit 22. The data processing device can have a function of extracting data from a database outside the memory unit 22, the data processing device, or the data processing system. Alternatively, the data processing device can have a function of extracting data from both of its own database and an external database.

One or both of a storage and a file server can be used as the memory unit 22. In addition, a database in which a path of a file stored in the file server is recorded can be used as the memory unit 22.

The memory unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The memory unit 22 can include at least one of a NOSRAM (registered trademark) and a DOSRAM (registered trademark). The memory unit 22 can include a memory media drive. Examples of the memory media drive include a hard disk drive (HDD) and a solid state drive (SSD).

Note that the NOSRAM is an abbreviation for "nonvolatile oxide semiconductor random access memory (RAM)". The NOSRAM refers to a memory in which a two-transistor (2T) or three-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by using characteristics of an extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for "dynamic oxide semiconductor RAM" and refers to a RAM including a one-transistor (1T) and one-capacitor (1C) memory cell. The DOSRAM is a DRAM formed using an OS transistor and temporarily stores data sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide contained in the channel formation region preferably contains indium (In). When the metal oxide contained in the channel formation region is a metal oxide containing indium, the carrier mobility (electron mobility) of the OS transistor is high. For example, indium oxide (InOx) or an indium gallium zinc oxide (an In-Ga-Zn oxide, also referred to as "IGZO") can be used for the channel formation region. The metal oxide contained in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium does. The metal oxide contained in the channel formation region is preferably a metal oxide containing zinc (Zn). The metal oxide containing zinc is easily crystallized in some cases.

The metal oxide contained in the channel formation region is not limited to the metal oxide containing indium. The metal oxide contained in the channel formation region may be, for example, a metal oxide that does not contain indium but contains any of zinc, gallium, and tin (e.g., a zinc tin oxide or a gallium tin oxide).

### Processing unit 23

The processing unit 23 has a function of performing processing such as arithmetic operation, analysis, and inference with use of data supplied from one or both of the input unit 21 and the memory unit 22. The processing unit 23 can supply generated data (e.g., an arithmetic operation result, an analysis result, or an inference result) to one or both of the memory unit 22 and the output unit 24.

The processing unit 23 has a function of obtaining data from the memory unit 22. The processing unit 23 can also have a function of storing or registering data in the memory unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the memory unit 22 and a memory region of the processor.

The processing unit 23 can include a main memory. The main memory includes at least one of a volatile memory such as a RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the memory unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while data processed immediately before turning off the processing unit is stored in the memory element. In other words, normally-off computing is possible and the power consumption of the data processing system can be reduced.

The data processing device preferably uses AI for at least part of its processing.

In particular, the data processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing data is referred to as "learning" in some cases.

In this specification and the like, drawing a new conclusion from a neural network formed with the connection strength obtained by learning is referred to as "inference" in some cases.

### Output unit 24

The output unit 24 can output at least one of an arithmetic operation result, an analysis result, and an inference result in the processing unit 23 to the outside of the data processing device. For example, the output unit 24 can transmit data via the network 51. Specifically, a device such as a personal computer having a communication port or a communication function can be used. Furthermore, a device having a communication function may be used as the input unit 21 and the output unit 24.

### Transmission path 25

The transmission path 25 has a function of transmitting data. Data transmission and reception between the input unit 21, the memory unit 22, the processing unit 23, and the output unit 24 can be performed via the transmission path 25. Specifically, an external bus, a LAN, or the Internet can be used for the transmission path 25.

This embodiment can be combined with another embodiment in this specification as appropriate.

### EMBODIMENT 2

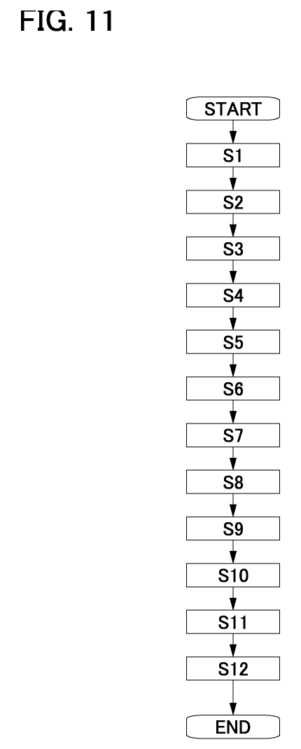

In this embodiment, data processing methods of one embodiment of the present invention will be described with reference to FIGS. 11, 12 and 13.

FIG. 11 is a flow diagram showing a data processing method of one embodiment of the present invention.

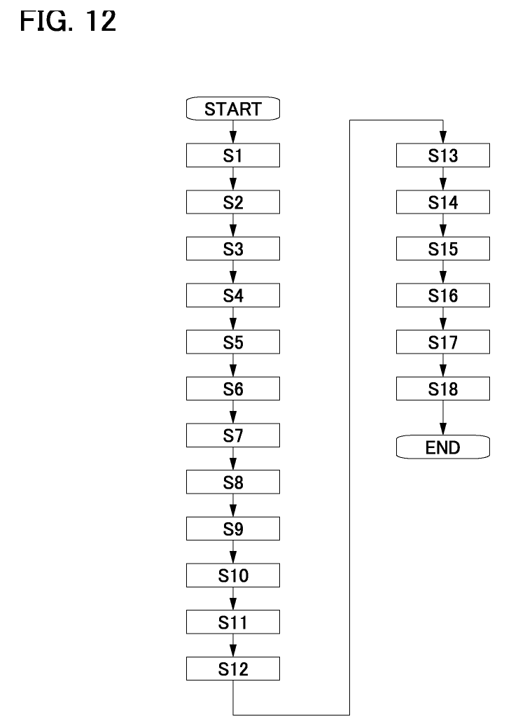

FIG. 12 is a flow diagram showing a data processing method of one embodiment of the present invention.

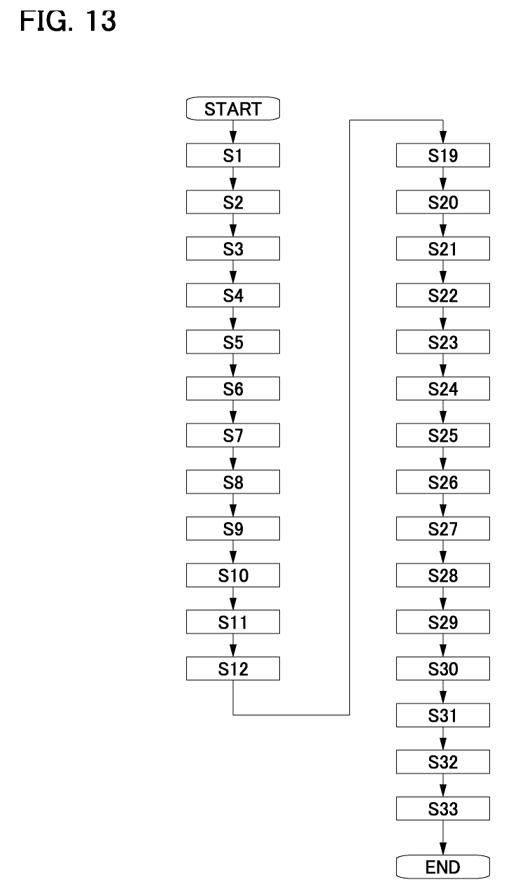

FIG. 13 is a flow diagram showing a data processing method of one embodiment of the present invention.

### Example 1 of data processing method

A data processing method of one embodiment of the present invention includes Steps S1 to S12 (see FIG. 11).

### Step S1

In Step S1, the component 110 receives the scope of claims PC, the document Doc, and the prior art literature Ref and transmits them to the component 120.

For example, the user 99 of the data processing system inputs the scope of claims PC, the document Doc, and the prior art literature Ref to the component 110. Alternatively, a command for selecting and transmitting the scope of claims PC, the document Doc, and the prior art literature Ref that are stored in the memory device is input to the component 110, for example.

### Step S2

In Step S2, the component 120 receives the scope of claims PC, the document Doc, and the prior art literature Ref and share them in the component 120.

The component 120 includes the subcomponent 120A and the subcomponent 120B.

### Step S3

In Step S3, the subcomponent 120A creates the prompt Pt11 and transmits it to the component 130.

The prompt Pt11 includes the instruction g11, the scope of claims PC, and the prior art literature Ref. The instruction g11 includes a procedure for extracting the description DoR related to the scope of claims PC from the prior art literature Ref.

### Step S4

In Step S4, the component 130 receives the prompt Pt11 and generates the description DoR with the use of the large language model LLM.

### Step S5

In Step S5, the component 130 transmits the description DoR to the component 120.

### Step S6

In Step S6, the component 120 receives the description DoR and shares it inside the component 120.

### Step S7

In Step S7, the subcomponent 120A creates the prompt Pt12 and transmits it to the component 130.

The prompt Pt12 includes the instruction g12, the description DoR, and the document Doc. The instruction g12 includes a procedure for searching the document Doc for the description DoD related to the description DoR and generating the positional data PI1 of the description DoD.

### Step S8

In Step S8, the component 130 receives the prompt Pt12 and generates the positional data PI1 with the use of the large language model LLM.

### Step S9

In Step S9, the component 130 transmits the positional data PI1 to the component 120.

### Step S10

In Step S10, the component 120 receives the positional data PI1 and shares it inside the component 120.

### Step S11

In Step S11, the subcomponent 120B creates the annotated document ADoc1 from the document Doc, the positional data PI1, and the description DoR and transmits the annotated document to the component 110.

The annotated document ADoc1 is the document Doc in which the annotation Ano1 is attached to the position identified by the positional data PI1, and the annotation Ano1 includes the description DoR.

### Step S12

In Step S12, the component 110 receives the annotated document ADoc1 and provides it to the user 99 of the data processing system, for example.

Through the above steps, the description DoR, which is related to the scope of claims PC, in the prior art literature Ref can be used in the annotation Ano1. In other words, in the annotation Ano1 attached to the description DoD, the description DoR, which is related to the scope of claims PC, in the prior art literature Ref can be used. With the use of the annotation Ano1, revision of the document Doc can be suggested to the user of the data processing system, for example. As a result, a novel data processing method that is highly convenient, useful, or reliable can be provided.

### Example 2 of data processing method

A data processing method of one embodiment of the present invention further includes Steps S13 to S18 (see FIG. 12). Note that Step S13 follows Step S12.

### Step S13

In Step S13, the subcomponent 120A creates the prompt Pt2 and transmits it to the component 130.

The prompt Pt2 includes the instruction g2, the description DoR, and the description DoD. The instruction g2 includes a procedure for generating the concise description BD from the description DoD with reference to the description DoR.

### Step S14

In Step S14, the component 130 receives the prompt Pt2 and generates the description BD with the use of the large language model LLM.

### Step S15

In Step S15, the component 130 transmits the concise description BD to the component 120.

### Step S16

In Step S16, the component 120 receives the concise description BD and shares it inside the component 120.

### Step S17

In Step S17, the subcomponent 120B creates the annotated document ADoc2 from the document Doc, the positional data PI1, and the concise description BD and transmits the annotated document to the component 110.

The annotated document ADoc2 is the document Doc in which the annotation Ano2 is attached to the position identified by the positional data PI1, and the annotation Ano2 includes the concise description BD.

### Step S18

In Step S18, the component 110 receives the annotated document ADoc2 and provides it to the user 99 of the data processing system, for example.

Through the above steps, the concise description BD can be generated from the description DoD in the document Doc. In other words, the concise description BD can be generated from the description DoD, which is related to the description DoR found in the prior art literature Ref. The annotation Ano2 can be attached to the position identified by the positional data PI1. An example of the concise description BD of the description DoD can be used in the annotation Ano2 which can be attached to the description DoD. With the use of the annotation Ano2, revision of the document Doc can be suggested to the user of the data processing system, for example. As a result, a novel data processing method that is highly convenient, useful, or reliable can be provided.

### Example 3 of data processing method

A data processing method of one embodiment of the present invention further includes Steps S19 to S33 (see FIG. 13). Note that Step S19 follows Step S12.

### Step S19

In Step S19, the subcomponent 120A creates the prompt Pt31 and transmits it to the component 130.

The prompt Pt31 includes the instruction g31, the scope of claims PC, and the document Doc. The instruction g31 includes a procedure for searching the document Doc for the description related to the scope of claims PC and generating the positional data PI2 from the position of the description related to the scope of claims.

### Step S20

In Step S20, the component 130 receives the prompt Pt31 and generates the positional data PI2 with the use of the large language model LLM.

### Step S21

In Step S21, the component 130 transmits the positional data PI2 to the component 120.

### Step S22

In Step S22, the component 120 receives the positional data PI2 and shares it inside the component 120.

### Step S23

In Step S23, the subcomponent 120A removes the positional data PI1 from the positional data PI2 to create the positional data PI3.

### Step S24

In Step S24, the subcomponent 120A creates the prompt Pt32 and transmits it to the component 130.

The prompt Pt32 includes the instruction g32, the document Doc, and the positional data PI3. The instruction g32 includes a procedure for extracting the technical feature TF from the description in the document Doc at the position identified by the positional data PI3.

### Step S25

In Step S25, the component 130 receives the prompt Pt32 and extracts the technical feature TF with the use of the large language model LLM.

### Step S26

In Step S26, the component 130 transmits the technical feature TF to the component 120.

### Step S27

In Step S27, the component 120 receives the technical feature TF and shares it inside the component 120.

### Step S28

In Step S28, the subcomponent 120A creates the prompt Pt4 and transmits it to the component 130.

The prompt Pt4 includes the instruction g4 and the technical feature TF. The instruction g4 includes a procedure for generating the abstract language expression ALE including the technical feature TF and the specific language expression ELE included in the technical feature TF.

### Step S29

In Step S29, the component 130 receives the prompt Pt4 and generates the abstract language expression ALE and the specific language expression ELE with the use of the large language model LLM.

### Step S30

In Step S30, the component 130 transmits the abstract language expression ALE and the specific language expression ELE to the component 120.

### Step S31

In Step S31, the component 120 receives the abstract language expression ALE and the specific language expression ELE and shares them inside the component 120.

### Step S32

In Step S32, the subcomponent 120B creates the annotated document ADoc3 from the document Doc, the positional data PI3, the abstract language expression ALE, and the specific language expression ELE and transmits the annotated document to the component 110.

The annotated document ADoc3 is the document Doc in which the annotation Ano3 is attached to the position identified by the positional data PI2, and the annotation Ano3 includes the abstract language expression ALE and the specific language expression ELE.

### Step S33

In Step S33, the component 110 receives the annotated document ADoc3 and provides it to the user 99 of the data processing system, for example.

Through the above steps, the description related to the scope of claims PC can be found from the document Doc, and the positional data PI2 of the description in the document Doc can be identified. The positional data PI3 can be identified by using the difference set obtained by removing the positional data PI1 from the positional data PI2. The positional data PI3 of the description that is related to the scope of claims PC and cannot be found in the prior art literature Ref can be identified. The technical feature TF can be extracted from the description in the document Doc at the position identified by the positional data PI3. The abstract language expression ALE including the technical feature TF and the specific language expression ELE included in the technical feature TF can be generated. The abstract language expression ALE including the technical feature TF and the specific language expression ELE included in the technical feature TF can be used in the annotation Ano3. The annotation Ano3 including the abstract language expression ALE and the specific language expression ELE can be attached to the position identified by the positional data PI3. With the use of the annotation Ano3, revision of the scope of claims PC or the document Doc can be suggested to the user of the data processing system, for example. In addition, the user of the data processing system can enrich a description that would be patentable, for example. As a result, a novel data processing method that is highly convenient, useful, or reliable can be provided.

This embodiment can be combined with the other embodiment in this specification as appropriate.

This application is based on Japanese Patent Application Serial No. 2025-044853 filed with Japan Patent Office on Mar. 19, 2025, the entire contents of which are hereby incorporated by reference.

What is claimed is:

1. A data processing system configured to:
receive a scope of claims, a document, and prior art literature; and
provide an annotated document,
wherein the prior art literature comprises a first description related to the scope of claims,
wherein the annotated document is obtained by attaching an annotation to a position of a second description, which is related to the first description, in the document, and
wherein the annotation comprises the first description.

2. A data processing system comprising:
a first component;
a second component; and
a third component,
wherein the first component is configured to receive a scope of claims, a document, and prior art literature and to transmit the scope of claims, the document, and the prior art literature to the third component,
wherein the prior art literature comprises a first description related to the scope of claims,
wherein the first annotated document comprises the document and a first annotation,
wherein the first annotated document is obtained by attaching the first annotation to a position identified by first positional data in the document,
wherein the second component is configured to receive a first prompt and a second prompt and to transmit the first description and the first positional data to the third component,
wherein the second component is configured to perform processing with a large language model,
wherein the large language model is configured to extract the first description in accordance with the first prompt and to generate the first positional data in accordance with the second prompt,
wherein the third component is configured to receive the scope of claims, the document, the prior art literature, the first description, and the first positional data, to share the scope of claims, the document, the prior art literature, the first description, and the first positional data inside the third component, to create the first prompt and the second prompt, to transmit the first prompt and the second prompt to the second component, to create the first annotated document, and to transmit the first annotated document to the first component,
wherein the third component comprises a first subcomponent and a second subcomponent,
wherein the first subcomponent is configured to create and execute a first prompt chain,
wherein the first prompt chain comprises the first prompt and the second prompt,
wherein the first prompt comprises a first instruction, the scope of claims, and the prior art literature,
wherein the first instruction comprises a procedure for extracting the first description related to the scope of claims from the prior art literature,
wherein the second prompt comprises a second instruction, the first description, and the document,
wherein the second instruction comprises a procedure for searching the document for a second description related to the first description and generating the first positional data from a position of the second description, and
wherein the second subcomponent is configured to create the first annotated document from the document and the first positional data.

3. The data processing system according to claim 2,
wherein the first annotation comprises the first description, and
wherein the second subcomponent is configured to create the first annotated document from the document, the first positional data, and the first description.

4. The data processing system according to claim 2,
wherein the first component is configured to receive a second annotated document,
wherein the second annotated document comprises the document and a second annotation,
wherein the second annotated document is obtained by attaching the second annotation to the position identified by the first positional data in the document,
wherein the second annotation comprises a concise description,
wherein the second component is configured to receive a third prompt and to transmit the concise description to the third component,
wherein the large language model is configured to generate the concise description in accordance with the third prompt,
wherein the third component is configured to transmit the third prompt to the second component, to receive the concise description, to share the concise description inside the third component, and to create the second annotated document and transmit the second annotated document to the first component,
wherein the first subcomponent is configured to create the third prompt,
wherein the third prompt comprises a third instruction, the first description, and the second description,
wherein the third instruction comprises a procedure for generating the concise description from the second description with reference to the first description, and
wherein the second subcomponent is configured to create the second annotated document from the document, the first positional data, and the concise description.

5. The data processing system according to claim 4,
wherein the first component is configured to receive and provide a third annotated document,
wherein the third annotated document comprises the document and a third annotation,
wherein the third annotated document is obtained by attaching the third annotation to a position identified by second positional data in the document,
wherein the third annotation comprises an abstract language expression and a specific language expression,
wherein the second component is configured to receive a fourth prompt, a fifth prompt, and a sixth prompt and to transmit the third positional data, a technical feature, the abstract language expression, and the specific language expression to the third component,
wherein the large language model is configured to generate the third positional data in accordance with the fourth prompt, to extract the technical feature in accordance with the fifth prompt, and to generate the abstract language expression and the specific language expression in accordance with the sixth prompt,
wherein the third component is configured to create the fourth prompt, the fifth prompt, and the sixth prompt, to transmit the fourth prompt, the fifth prompt, and the sixth prompt to the second component, to receive the third positional data, the technical feature, the abstract language expression, and the specific language expression, to share the third positional data, the technical feature, the abstract language expression, and the specific language expression inside the third component, to create the third annotated document, and to transmit the third annotated document to the first component,
wherein the first subcomponent is configured to create and execute a second prompt chain and to create second positional data,
wherein the second prompt chain comprises the fourth prompt and the fifth prompt,
wherein the second positional data is a difference set obtained by removing the first positional data from the third positional data,
wherein the fourth prompt comprises a fourth instruction, the scope of claims, and the document,
wherein the fourth instruction comprises a procedure for searching the document for a description related to the scope of claims and generating the third positional data from a position of the description related to the scope of claims,
wherein the fifth prompt comprises a fifth instruction, the document, and the second positional data,
wherein the fifth instruction comprises a procedure for extracting the technical feature from a description in the document at a position identified by the second positional data,
wherein the sixth prompt comprises a sixth instruction and the technical feature,
wherein the sixth instruction comprises a procedure for generating the abstract language expression comprising the technical feature and the specific language expression included in the technical feature, and
wherein the second subcomponent is configured to create the third annotated document from the document, the second positional data, the abstract language expression, and the specific language expression.

6. A data processing method comprising a first step, a second step, a third step, a fourth step, a fifth step, and a sixth step,
wherein in the first step, a first component receives a scope of claims, a document, and prior art literature and transmits the scope of claims, the document, and the prior art literature to a second component comprising a first subcomponent and a second subcomponent,
wherein in the second step, the first subcomponent creates a first prompt comprising the scope of claims, the prior art literature, and a first instruction including a procedure for extracting a first description related to the scope of claims from the prior art literature and transmits the first prompt to a third component,
wherein in the third step, the third component receives the first prompt, generates the first description using a large language model in accordance with the first prompt, and transmits the first description to the second component,
wherein in the fourth step, the first subcomponent creates a second prompt comprising the first description, the document, and a second instruction including a procedure for searching the document for a second description related to the first description and generating first positional data from a position of the second description and transmits the second prompt to the third component,
wherein in the fifth step, the third component receives the second prompt, generates the first positional data using the large language model in accordance with the second prompt, and transmits the first positional data to the second component,
wherein in the sixth step, the second subcomponent creates a first annotated document from the document, the first positional data, and the first description and transmits the first annotated document to the first component, and
wherein the first annotated document is obtained by attaching a first annotation comprising the first description to the position identified by the first positional data in the document.

7. The data processing method according to claim 6, further comprising a seventh step following the sixth step, an eighth step, and a ninth step,
wherein in the seventh step, the first subcomponent creates a third prompt comprising the first description, the second description, and a third instruction including a procedure for generating a concise description from the second description with reference to the first description and transmits the third prompt to the third component,
wherein in the eighth step, the third component receives the third prompt and generates the concise description using the large language model in accordance with the third prompt and transmits the concise description to the second component,
wherein in the ninth step, the second subcomponent creates a second annotated document from the document, the first positional data, and the concise description and transmits the second annotated document to the first component, and
wherein the second annotated document is obtained by attaching a second annotation comprising the concise description to the position identified by the first positional data in the document.

8. The data processing method according to claim 7, further comprising a tenth step following the ninth step, an eleventh step, a twelfth step, a thirteenth step, a fourteenth step, a fifteenth step, a sixteenth step, and a seventeenth step,
wherein in the tenth step, the first subcomponent creates a fourth prompt comprising the scope of claims, the document, and a fourth instruction including a procedure for searching the document for a description related to the scope of claims and generating second positional data from a position of the description related to the scope of claims and transmits the fourth prompt to the third component,
wherein in the eleventh step, the third component receives the fourth prompt and generates the second positional data using the large language model in accordance with the fourth prompt and transmits the second positional data to the second component,
wherein in the twelfth step, the first subcomponent creates third positional data by removing the first positional data from the second positional data,
wherein in the thirteenth step, the first subcomponent creates a fifth prompt comprises the document, the third positional data, and a fifth instruction including a procedure for extracting a technical feature from a description in the document at a position identified by the third positional data and transmits the fifth prompt to the third component,
wherein in the fourteenth step, the third component receives the fifth prompt, extracts the technical feature using the large language model in accordance with the fifth prompt, and transmits the technical feature to the second component,
wherein in the fifteenth step, the first subcomponent creates a sixth prompt comprising the technical feature and a sixth instruction including a procedure for generating an abstract language expression comprising the technical feature and a specific language expression included in the technical feature and transmits the sixth prompt to the third component,
wherein in the sixteenth step, the third component receives the sixth prompt, generates the abstract language expression and the specific language expression using the large language model in accordance with the sixth prompt, and transmits the abstract language expression and the specific language expression to the second component,
wherein in the seventeenth step, the second subcomponent creates a third annotated document from the document, the third positional data, the abstract language expression, and the specific language expression and transmits the third annotated document to the first component, and
wherein the third annotated document is obtained by attaching a third annotation comprising the abstract language expression and the specific language expression to the position identified by the third positional data in the document.
